(19) United States
(12) Patent Application Publication
(10) Pub. No.: US 2013/0083855 A1
(43) Pub. Date: Apr. 4, 2013

(54) ADAPTIVE COLOR SPACE SELECTION FOR HIGH QUALITY VIDEO COMPRESSION

(71) Applicant: Dane P. Kottke, Lebanon, NH (US)

(72) Inventor: Dane P. Kottke, Lebanon, NH (US)

(21) Appl. No.: 13/250,418

(22) Filed: Sep. 30, 2011

(51) Int. Cl. H04N 7/30; H04N 11/04

(52) U.S. Cl. 375/240.18; 375/240.03; 375/E07.127; 375/E07.226

(57) ABSTRACT

Intraframe video compression schemes are optimized for compression of high quality media, such as media encoded in RGB 4:4:4 format. The optimization uses an encoder that applies a 2D spatial linear transform to subframe portions of image data to generate coefficients, adaptively selects a favored color space representation for representing the coefficients, and signals the selected color space representation in the compressed video stream. The selection of color space for each subframe image portion is performed by comparing the compression efficiency of the portion in each of a plurality of color spaces. To minimize computational cost, efficiencies are estimated by applying rate-distortion models for the applied compression scheme to coefficients of each portion.

### BACKGROUND

The quality of digital video used in broadcasting and movie recordings and downloads continues to increase. Such improvements are usually accompanied by the adoption of larger raster sizes, and of more faithful encoding formats, such as uncompressed RGB 4:4:4 as opposed to in the YCrCb 4:2:2. When viewing video in such improved formats, any compression artifacts become more prominent and also less acceptable to viewers who have raised expectations of image quality.

However, such increases in quality come with an increase in the corresponding data throughput rate, with attendant increased storage capacity and I/O rate requirements, as well as higher bandwidths needed for transmission. Despite bandwidth constraints that affect broadcasters and recording/playback devices, many users do not want their video to be converted from a native encoding, such as RGB 4:4:4 to any other color space since they fear it will result in a loss of color fidelity and visual quality. Thus video processing systems are required that can receive high quality formats such as RGB 4:4:4, and output the same format after processing, while at the same time optimizing storage, bandwidth, and processing requirements. Yet such optimization requires working with compressed video, which can negatively affect fidelity and quality.

### SUMMARY

The intraframe DN×HD compression scheme is adapted for optimal compression of high quality media, such as media encoded in RGB 4:4:4 format. The described encoding methods adaptively select a favored color space representation for compression at a subframe level for a given set of input video, and then signal the color space representation in the compressed video stream. When the compressed data is decompressed, the decoder uses the color space signal to apply the decompression appropriate to the color space for each subframe.

In general, in one aspect, a method for intraframe compression of video, wherein the video includes a sequence of images represented in a first color space, includes for each image: segmenting the image into a plurality of portions; for each portion of the image: applying a two-dimensional (2D) spatial linear transform to the portion to generate coefficients corresponding to the first color space; transforming the coefficients corresponding to the first color space by applying a color space transform to generate coefficients corresponding to a second color space; if applying the color space transform causes clipping of coefficient data, compressing the coefficients corresponding to the first color space; if applying the color space transform does not cause clipping of the coefficients, compressing the coefficients corresponding to the second color space; and outputting the compressed coefficient data together with an indication of the color space in which the coefficients for the portion are compressed.

Various embodiments include one or more of the following features. Compressing the coefficients comprises: selecting, from a plurality of stored quantization matrices each defined for a respective one of a plurality of distortion levels, a quantization matrix for the image according to a desired distortion level for the sequence of images; determining a distortion level for the transformed portion of the image using a plurality of scale factors; estimating a bit rate for the portion according to the plurality of scale factors; selecting a scale factor for the portion to minimize the overall bit rate for the compressed image while achieving a desired distortion level; quantizing the frequency domain coefficients for the portion using the selected quantization matrix as scaled by the selected scale factor for the portion; and entropy encoding the quantized coefficients using a variable length encoding to provide compressed data for the portion. The first color space is an RGB color space, such as an RGB 4:4:4 color space. The second color space is a YCbCr 4:4:4 color space. Each of the plurality of portions of the image comprises a block of 16 by 16 pixels. The 2D spatial linear transform is a discrete cosine transform or a wavelet transform. Compressing the coefficients comprises: selecting, from a plurality of stored quantization matrices each defined for a respective one of a plurality of bit rates, a quantization matrix for the image according to a desired bit rate of the plurality of bit rates for the sequence of images; determining a distortion metric for the transformed portion of the image using a plurality of scale factors; estimating a bit rate for the portion according to the plurality of scale factors; selecting a scale factor for the portion to minimize the total distortion in the image, while achieving a desired bit rate; quantizing the frequency domain coefficients for the portion using the selected quantization matrix as scaled by the selected scale factor for the portion; and entropy encoding the quantized frequency domain coefficients using a variable length encoding to provide compressed data for the portion.

In general, in another aspect, a method for intraframe compression of video, wherein the video includes a sequence of images represented in a first color space, includes, for each image: segmenting the image into a plurality of portions; for each portion of the image: applying a 2D spatial linear transform to the portion to generate coefficients corresponding to the first color space; transforming the coefficients by applying a color space transform to generate coefficients corresponding to a second color space for the portion; if applying the color space transform causes clipping of the coefficients, compressing the coefficients corresponding to the first color space; if applying the color space transform does not cause clipping of the coefficients: determining a first and a second compression efficiency of compressing the coefficients for the portion corresponding to the first and second color spaces respectively; comparing the first and second compression efficiencies to determine an optimal one of the first and second color spaces that yields a greater compression efficiency for the portion; compressing the coefficients corresponding to the optimal one of the first and second color spaces; and outputting the compressed data for the portion together with an indication of the optimal one of the first and second color spaces for the portion.

Various embodiments include one or more of the following features. Determining compression efficiency corresponding to a color space involves computing a number of bits in a compressed bitstream representing the coefficients without actually computing the compressed bitstream itself. Computing the number of bits in the compressed bitstream is based on a bit-cost model of the number of bits required to represent the portion for a given distortion level.

In general, in a further aspect, a method for compression of multi-channel image data represented in a first color space, includes: segmenting the image data into a plurality of portions; for each portion of the image: transforming the portion using a 2D spatial linear transform to generate coefficients corresponding to the first color space; determining a compression efficiency of compressing the coefficients corresponding to the first color space for the portion; for each of one or more additional color spaces: transforming the coefficients by applying a color space transform to generate coefficients corresponding to the additional color space; and if applying the color space transform does not cause clipping of the coefficients determining a compression efficiency of compressing the coefficients for the portion corresponding to the additional color space; comparing the compression efficiencies corresponding to the first color space and each of the one or more additional color spaces to determine an optimal color space that yields a greatest compression efficiency for the portion; compressing the coefficients corresponding to the optimal color space to generate compressed image data for the portion; and outputting the compressed image data for the portion together with an indication of the optimal color space for the portion.

Various embodiments include one or more of the following features. The first color space is one of a CMYK and a YCbCrK color space. The first color space is a CMYK color space and an additional color space is a YYCC color space. The multi-spectral image data represents a still image. The multispectral image data represents a temporal sequence of images.

In yet another aspect, a computer program product includes: a computer-readable medium with computer program instructions encoded thereon, wherein the computer program instructions, when processed by a computer, instruct the computer to perform a method for intraframe compression of video, wherein the video includes a sequence of images represented in a first color space, the method comprising, for each image: segmenting the image into a plurality of portions; for each portion of the image: applying a 2D spatial linear transform to the portion to generate coefficients corresponding to the first color space; transforming the coefficients corresponding to the first color space by applying a color space transform to generate coefficients corresponding to a second color space; if applying the color space transform causes clipping of coefficient data, compressing the coefficients corresponding to the first color space; if applying the color space transform does not cause clipping of the coefficients, compressing the coefficients corresponding to the second color space; and outputting the compressed coefficient data together with an indication of the color space in which the coefficients for the portion are compressed.

In still a further aspect, a computer system for intraframe compression of video, wherein the video includes a sequence of images represented in a first color space, includes: a processor programmed to: for each image of the sequence of images: input the image; segment the image into a plurality of portions; for each portion of the image: apply a 2D spatial linear transform to the portion to generate coefficients corresponding to the first color space; transform the coefficients corresponding to the first color space by applying a color space transform to generate coefficients corresponding to a second color space; if applying the color space transform causes clipping of coefficient data, compress the coefficients corresponding to the first color space; if applying the color space transform does not cause clipping of the coefficients, compress the coefficients corresponding to the second color space; and output the compressed coefficient data together with an indication of a color space in which the coefficients for the portion are compressed.

In an additional aspect, a method for decompression of compressed multi-channel image data, wherein the compressed image data was generated by intraframe compression of a sequence of multi-channel images represented in a source color space, includes, for each image: receiving a bitstream of intraframe compressed image data; determining an associated quantization matrix for the compressed bitstream; entropy decoding the compressed data using variable length decoding to obtain quantized 2D spatial linear transform domain coefficients for defined portions of the image; and for each portion: determining a scale factor for the portion; inverse quantizing the 2D spatial linear transform domain coefficients for the portion using the associated quantization matrix as scaled by the determined scale factor for the portion; reading a color space signal in the received bitstream for the portion that indicates a color space in which the compressed data for the portion is represented; if the color space for the portion is not the source color space, applying an inverse color space transform to transform the data for the portion from the color space to the source color space; and inverse transforming the dequantized, source color space 2D spatial linear transform domain coefficients for each portion to generate a portion of the image.

### BRIEF DESCRIPTION OF THE DRAWINGS

FIG. 1 is a high level flow diagram illustrating the DN×HD compression scheme.

FIG. 2 is a high level flow diagram of the steps involved in compressing a frame of digital video according the described embodiment.

FIG. 3 is a high level flow diagram of alternative color space evaluation in the described compression scheme.

FIG. 4 illustrates a bitstream format for compressed video data according to the described compression scheme.

FIG. 5 is a high level flow diagram illustrating the steps involved in a generalized video compression scheme involving linear transformation of coding groups and evaluation of the compression efficiency of multiple color spaces.

FIG. 6 is a flow diagram of an example encoder for compression of image data coefficients.

FIG. 7 is a flow diagram of an example decoder for decompression of a sequence of images.

### DETAILED DESCRIPTION

It is well known that color space representation of video data affects compression efficiency. For example, the RGB color space often contains considerable inter-channel correlation between the red, green, and blue channels. This redundant information must be encoded for each channel, thereby increasing the bit cost of the compressed data. On the other hand, in most video data, the YCbCr channels are relatively de-correlated; each channel contains mostly unique information. Since there is less redundancy between channels, the bit-cost to encode the video raster is lower. As a result, the YCbCr color space is considered to have better compression efficiency than the RGB color space.

The methods and systems described herein provide improved intraframe compression of digital video and multi-spectral image data. The improvement involves considering the gamut of alternate color spaces for a given uncompressed video presented to the encoder. The evaluation and selection of color space is performed at a subframe level, for example at the macroblock level. Such adaptive color space selection leads to improved color fidelity for a given bit rate (or a lower bit rate for a given level of color fidelity). The color space selection is signaled in the compressed bitstream syntax. The decoder uses this information to dynamically switch color space representation during the decoding process.

The compression improvement is a general method, applicable to any high bit rate video as well as to individual multi-channel images, i.e., still imagery, and to multi-channel image sequences. In general, video comprises a sequence of images represented in a three-channel color space, such as RGB and YCbCr. Multi-channel images or image sequences may be represented by four or more channels such as the four channel CMYK data used in printing applications, and the multiple, multi-spectral channels used in remote sensing applications. The improvement is applicable, for example, to compression schemes based on DCTs and wavelets, or to schemes based on other 2D linear spatial transforms. The described embodiment is an improvement over the VC-3 (DN×HD) video codec. The DN×HD codec is described in U.S. Pat. Nos. 7,403,561 and 7,729,423, both entitled “Fixed Bit Rate Intraframe Compression and Decompression of Video,” which are incorporated herein in their entirety.

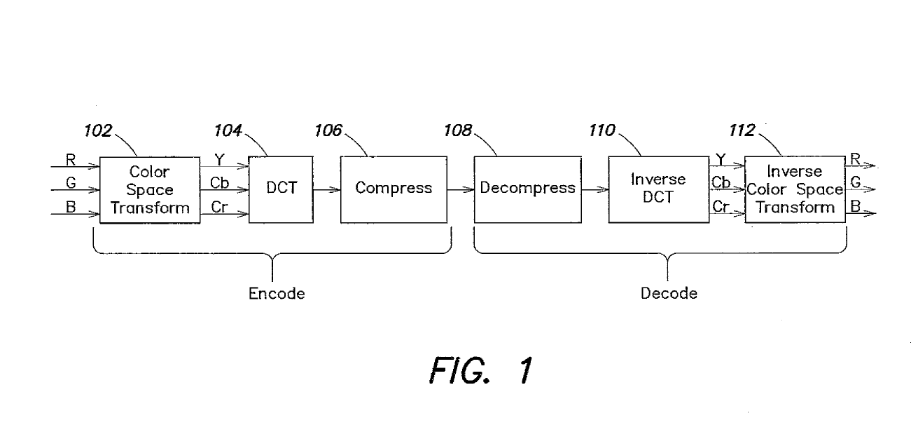

In the DN×HD codec, schematically illustrated in the flow diagram shown in FIG. 1, video that is received as RGB 4:4:4 first undergoes a color space transformation to YCbCr 4:2:2 (102). The YCbCr data is then transformed into frequency coefficients using a discrete cosine transform (DCT, 104), which are then compressed (106) by scaling, quantization, and entropy encoding, as described in the patents referred to above. The scaling and quantization steps are described in detail below. When the compressed data is received by the decoder, the compression steps are reversed (108), an inverse DCT is applied (110), and the YCbCr data is transformed back to RGB (112) and output.

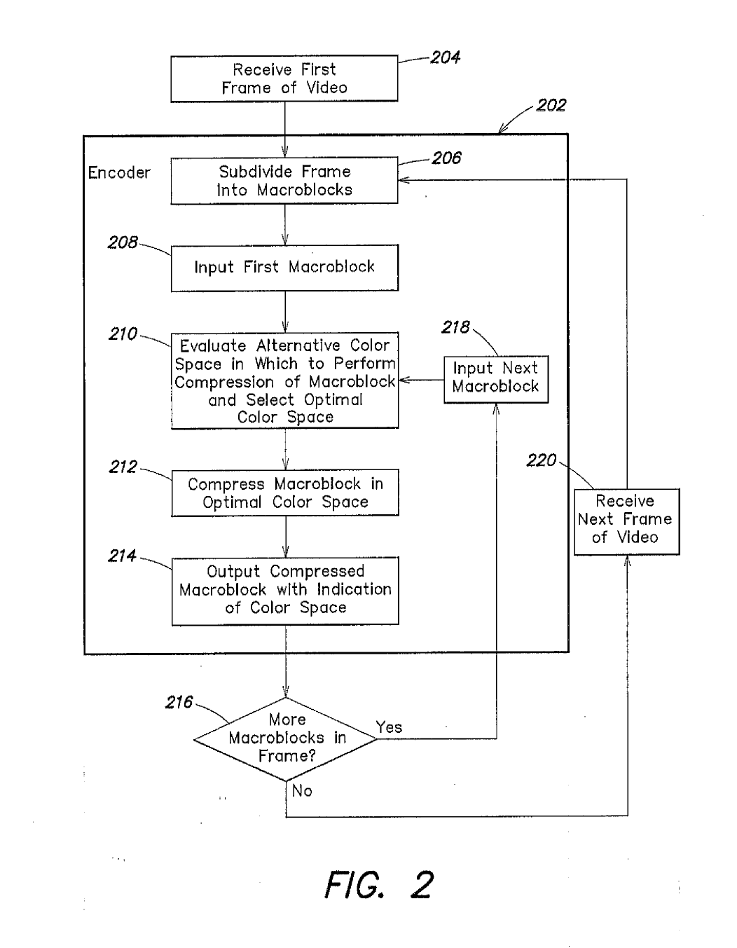

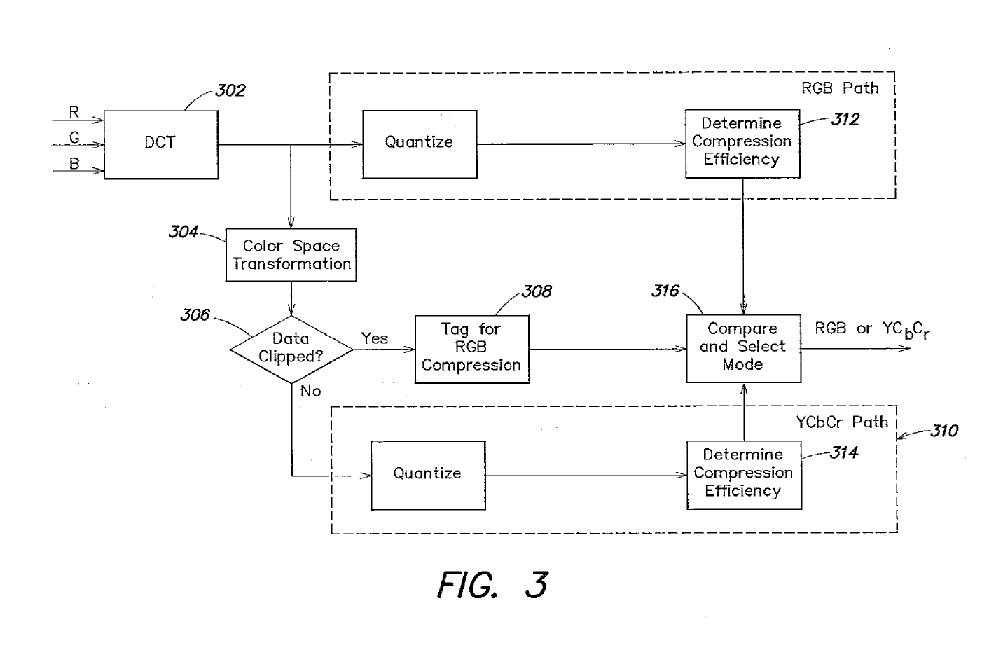

High level flow diagrams of the steps involved in compressing video according to the improved methods described herein are shown in FIGS. 2 and 3. Encoder 202 receives the frame of video (204) and segments the data into macroblocks (206), each macroblock consisting of a block of 16×16 pixels. The method may also be applied to still images, in which case the received image is not a part of a video sequence. In the described embodiment, the incoming, uncompressed data is received at the encoder as RGB 4:4:4 data. The encoder inputs the first macroblock (208), and after performing a spatial linear transform (not shown in the figure), evaluates compression of the transformed macroblock data when represented in the color space in which it was received, e.g., RGB 4:4:4, as well as when the transformed macroblock data is represented in one or more alternative color spaces, such as YCbCr 4:4:4. The encoder compares the compression efficiency of each of the evaluated color spaces, and selects the one that yields the optimal compression efficiency (210). This step is discussed in more detail below in connection with FIG. 3. The encoder then compresses the macroblock using the selected color space (212), and outputs the compressed bitstream with an indication of the color space that was selected (214). If there are additional macroblocks to be encoded for the frame (216), the next one is input (218), and the process is repeated until all macroblocks for the frame have been encoded. The encoder then requests and receives (220) the next frame, and repeats the process for each frame of the video to be compressed.

Color space evaluation step 210 is now described in more detail in connection with the high level flow diagram shown in FIG. 3. The uncompressed data for each macroblock are first passed through a 2D spatial linear transform, such as DCT (302) before any color space transformations are performed. Next, the frequency coefficients of the RGB data are transformed into an alternate color space, such as YCrCb4:4:4 using a color space transformation (304). Some color space choices change the dynamic range of the video data, which may result in clipping of the data due to hardware, software or other constraints on the compressed bitstream. If the color space transformation results in any clipping of the data (306), the macroblock is tagged for compression in ROB color space, i.e., no color space transform is used, 308. In most cases, no clipping will occur, and the encoder may simply use the YCbCr data for compression (310) due to its generally better compression efficiency. Such an approach has the benefit of requiring no computation that is additional to what is needed for compression. However, it may mean that some compression efficiency is sacrificed if some macroblocks would have been more efficiently compressed using RGB data.

In an alternative method, a “best pick” approach is taken for each macroblock. The best pick approach uses rate-distortion optimization to select the optimal color space for each macroblock. For variable rate compression, the macroblock distortion level is set, and the color space with the smaller bit count it selected. The encoder determines the number of bits required to compress each macroblock in each of the RGB space (312) and the YCbCr space (314) for a given distortion rate, compares the results and selects the color space requiring the smaller number of bits (316). The comparison is performed using the encoding cost of the macroblock's quantized coefficient data. Alternatively, for fixed bit rate compression, the macroblock bit rate is set, and the color space with the smaller distortion level is selected. To reduce computational cost, the encoded bitstream does not need to be computed. Instead, rate-distortion models, which provide a relationship between bit cost and distortion level, for a given set of uncompressed data, are used to predict the hit-cost or distortion. The rate-distortion models may be analytic models or empirical models, some of which are discussed in “Bit-Rate Control Using Piecewise Approximated Rate-Distortion Characteristics” by Lang-Jin Lin, IEEE Transactions on Circuits and Systems for Video Technology, Vol. 8, No. 4, August 1998, and in “A Unified Rate-Distortion Analysis Framework for Transform Coding” by Zhihai He and Sanjit Mitra, IEEE Transactions on Circuits and Systems for Video Technology, Vol, 11, No. 12, December 2001. The color space that optimizes the distortion level or bit rate is selected for the macroblock, and the macroblock compression is then completed in the selected color space.

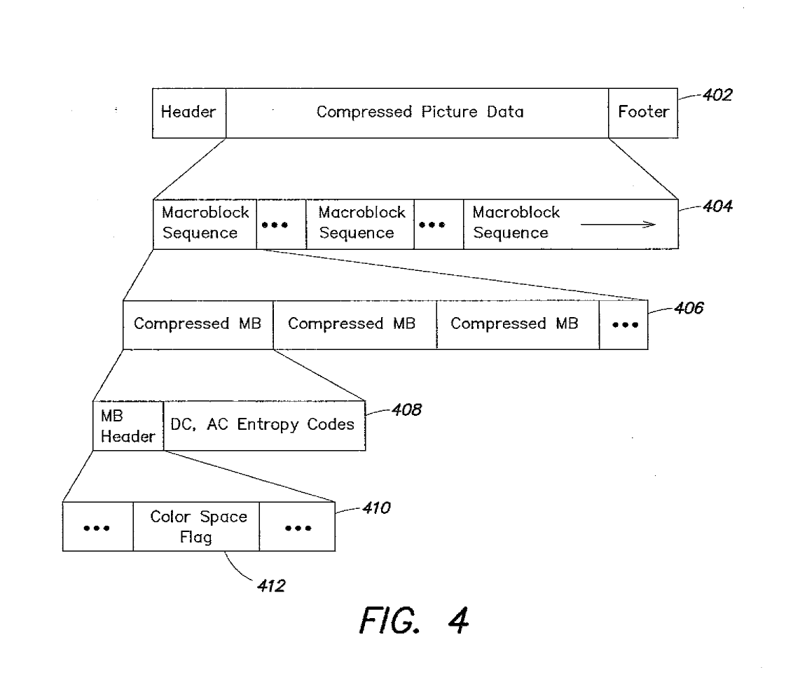

The resulting bitstream is tagged with a color space flag for each compressed macroblock to indicate which color space was selected for compression, using, for example, a reserved bit or bits in the compressed bitstream. The reserved bits, may reside at any location within the compressed bitstream. A particular choice of location is illustrated in FIG. 4, with the color space flag residing near the other macroblock information in the macroblock header. The figure illustrates a bitstream for a compressed image (402), the series of macroblock sequences (404), each macroblock sequence representing a set of macroblocks of image data being compressed (406), a header and compressed data for each compressed macroblock (408), and a compressed macroblock header (410) including a color space flag (412). The number of bits required for the color space flag depends on the number of different color space choices. When the data is decompressed, the decoder uses this bit to switch color space representation dynamically during the decoding process.

After color space selection, the compression proceeds in a manner similar to that of the DN×HD compression scheme. The steps involved include scaling, quantization, and Huffman encoding in a manner similar to that described in U.S. Pat. No. 7,403,561, and described below.

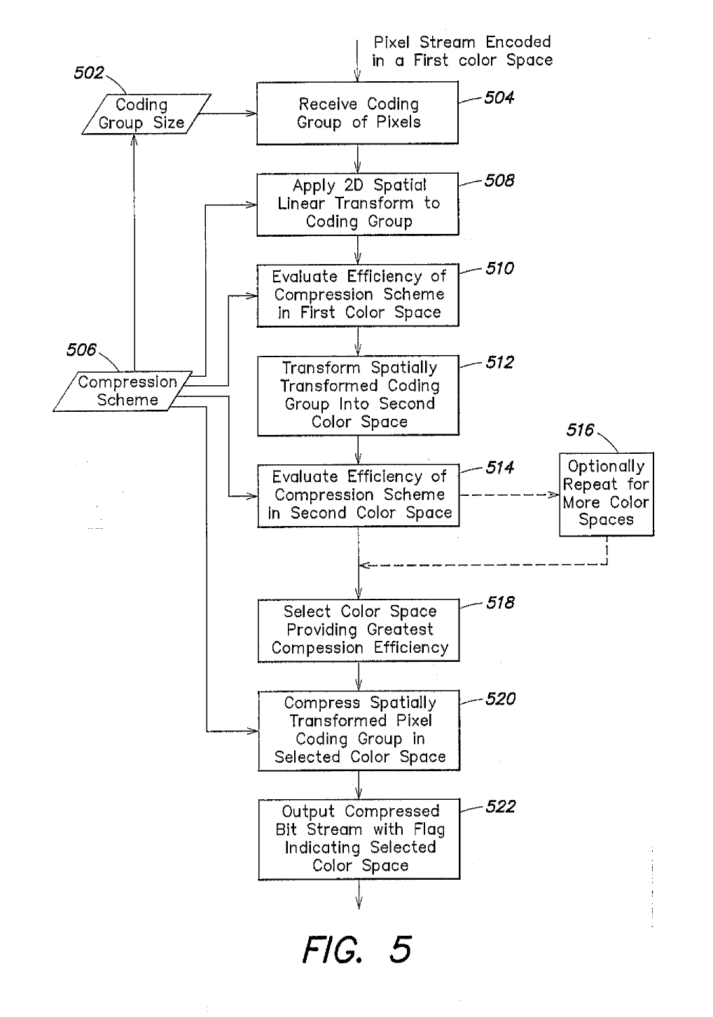

Compression optimization via adaptive color space selection at the subframe level is not limited to uncompressed RGB 4:4:4, nor to the described alternate color space or compression scheme. A high level flow diagram illustrating the general form of the described methods appears in FIG. 5. A stream of uncompressed pixel data represented in a first color space is segmented into coding groups having a specified coding group size (502), the size of the group being determined in part by the compression scheme to be used (506). An uncompressed coding group is received by the compression encoder (504). The coding group may be smaller or larger than the 16×16 pixel macroblock used in the described embodiments. In particular, other coding group sizes may include 8×8, 4×4, or other macroblock sizes. For DCT-based transform compression systems, there is a trend toward increasing macroblock sizes and adaptive macroblock sizes as proposed in “High-Definition Video Coding with Super-Macroblocks”, by S. Ma and C.-C. Jay Kuo, in Visual Communications and Image Processing, January 2007. The adaptive macroblock sizes can be accommodated within the scope of various embodiments of the encoding methods described herein. Additionally, wavelet based compression systems, such as JPEG-2000, group regions of pixels into tiles of varying size depending upon application and performance requirements. Such groupings of the raster may also be used with the techniques described herein. Most generally, coding groups, which may be considered as disjoint partitions of the image or video raster, are grouped and rate/distortion tradeoffs of each coding group are made to meet performance requirements.

The choice of uncompressed data color space representation is not limited to RGB and YCbCr. Other compression formats support color spaces similar but not the same as color space as YCbCr. H.264 with FRExt offers an alternate color space called YCoCg, as described in G. Sullivan, P. Topiwala, and A. Luthra, “The H.264/AVC Advanced Video Coding Standard: Overview and Introduction to the Fidelity Range Extensions,” in Proc. of SPIE 5558, Conference on Applications of Digital Image Processing XXVII, August, 2004. The compression standard JPEG-2000 supports the Reversible Color Transform (RCT) as described in D. S. Taubman and M. W. Marcellin, JPEG 2000. Image Compression Fundamentals, Standards, and Practices, Kluwer Academic Publishers, 2002. In both cases, the concepts described herein are applicable to the YCoCg and RCT color spaces, but require changes to the compression standards in order to indicate color space selection for the macroblock or tile.

Additionally, the concept is not limited to data with only three channels or to applications with only two color spaces, but may be extended to multi-spectral image data where the number of channels is greater than three and/or the number of color space choices is larger than two. In “On Independent Color Space Transformations for the Compression of CMYK Images,” by Ricardo L. de Queiroz, IEEE Trans. On Image Processing, Vol. 8, No. 10, October 1999, a compression performance analysis is made between the CMYK, YCbCrK, and YYCC color spaces using the JPEG image compression standard. This paper describes how compression can be performed on a 4-channel data representation. The additional channel is simply accounted for in the color space transformation (512) and subsequent encoding/decoding process through additional computation. The dimensionality of data is independent of the process of the color space selection. Moreover, multiple color space choices can be evaluated by a looping process as indicated in FIG. 5, 516.

In the next step, a 2D spatial linear transform corresponding to the selected compression scheme (506) is applied (508) to the coding group to generate coefficients representing the pixel data in the space corresponding to the linear transform. In the described embodiment, the spatial transform is a 2D DCT, and the transformed data are spatial frequency representations of the input pixel data. For wavelet compression a 2D wavelet transform is applied to the coding group and the result is a multi-level wavelet decomposition.

Following the application of the spatial transform, the compression efficiency of the compression scheme in the first color space is determined within the rate-distortion framework discussed above (510). The type of rate-distortion optimization techniques referred to herein have been utilized in a wide range of image compression applications and formats, including wavelets, DCT and approximate DCT transforms and vector quantization. Next, the data is transformed into a second color space (512) for evaluation of compression efficiency at the coding group level in the second color space (514). The selection of the second color space is dependent upon the application. For example image and video applications include YCbCr color space, the YCoCg color space as defined in H.264, or the RCT color space as defined in JPEG200. Digital publishing applications might include YCbCrK or YYCC. In each case, the second color space is rejected if transformation of the data into that space results in clipping. In various embodiments, the transform applied in step 512 may not correspond to one of the known color spaces. Instead, the transform may be an arbitrary linear transform selected solely for the purpose of optimizing compression efficiency according to the application. However, the additional computational cost of determining the appropriate expansion for each macroblock may outweigh the benefit of increased compression efficiency. The coefficient data for the coding group in the first color space may be transformed into further color spaces, and, provided there is no clipping, the compression efficiency in each of the additional color spaces determined. The encoder then selects the color space that provides the greatest compression efficiency (518), and proceeds to complete the compression of the coding group in the selected color space (520). It then outputs the compressed bitstream (522), together with a signal (such as a color flag as illustrated in FIG. 4) indicating the color space selected for that coding group.

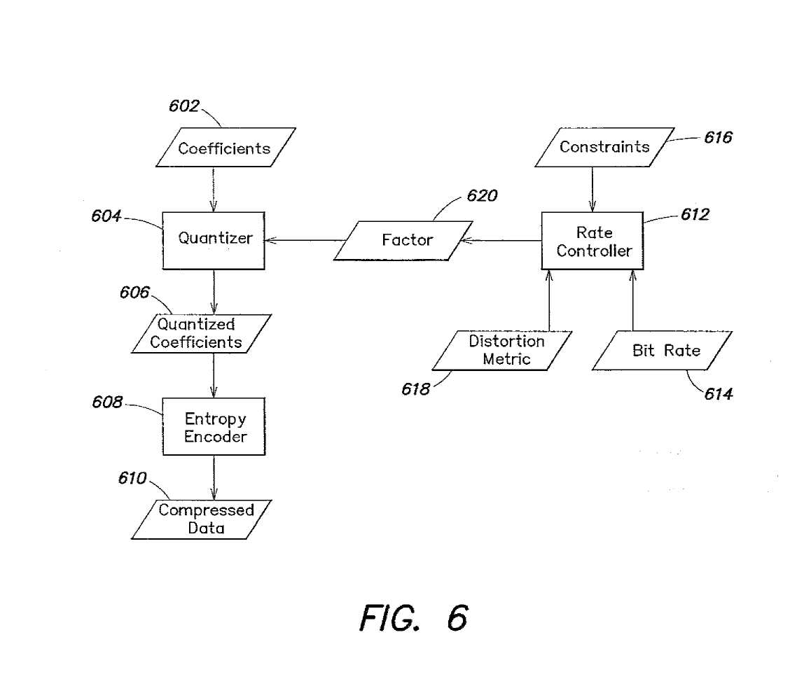

We now describe compression of the image data coefficients corresponding to the optimal color space selected for a given macroblock. FIG. 6 illustrates a system for compressing the image data coefficients, i.e., the image data resulting from application of the 2D spatial linear transform to the coding group (e.g., FIG. 5, step 508), Coefficients 602 are quantized by quantizer 604 using a set of quantizers, one quantizer for each coefficient, to provide a set of quantized coefficients 606 for the macroblock. The set of quantizers is typically referred to as a quantization table or quantization matrix. The quantization matrices appropriate for a particular bit rate, for example 220 Mbits per frame and 140 Mbits per frame, can be defined experimentally using sample images and a procedure defined in: “RD-OPT: An Efficient Algorithm for Optimizing DCT Quantization Tables,” by Viresh Ratnakar and Miron Livny, in 1995 Data Compression Conference, pp. 332-341 (“Ratnakar”). Ratnakar teaches how to optimize a quantization table for a single image; however, this procedure may be extended to optimize a quantization table using statistics for multiple example images selected as “typical” images. Such a quantization table can be developed for each of a set of different desired output bit rates and output distortion levels.

The quantization table is used to quantize the coefficients by dividing each coefficient by its corresponding quantizer and rounding. For example, the following formula may be used:

round[S(u,v)/Q(u,v)];

where S(u,v) is the value at position u,v in the matrix of frequency coefficients, Q(u,v) is the quantizer at position u,v in the quantization matrix. The values Q(u,v) in the quantization matrix may be a function of a fixed quantization matrix, a scale factor and a weighting factor. The weighting factor scales the values in the quantization matrix so that they are appropriate for the bit depth of the image data, so that the variability in dynamic ranges is accounted for by data of multiple bit depths, such as both 8-bit and 10-bit data.

The quantization also may be performed to provide a variable width “deadzone”. The deadzone is the area around zero that is quantized to zero. In the equation above, using rounding, the deadzone has a width of the quantizer value Q(u,v). Noise can be reduced by increasing the deadzone as a function of quantizer value, for example, using the following equations:

The quantized coefficient, c, is defined as:

$$c = \{ \begin{matrix}0 & \vert x \vert < {( 1 - k )}^{*} Q ( u , v ) \\ sgn ( x ) ⌊ \frac{\vert x \vert + kQ ( u , v )}{Q ( u , v )} ⌋ & \vert x \vert \geq {( 1 - k )}^{*} Q ( u , v )\end{matrix}$$

The dequantized value, \hat{x}, would be:

$$\hat{x} = \{ \begin{matrix}0 & c = 0 \\ sgn ( c ) ( \vert c \vert - k + δ ) Q ( u , v ) & c \neq 0\end{matrix}$$

where δ is typically one-half. Then the width of the deadzone equals 2 (1−k)Q(u,v)

With these equations, if k=0.5 and δ=0.5, the quantization/dequantization are conventional with a deadzone of width Q(u,v). For non-zero k the deadzone can be made variable, If k is in the interval (0, 0.5) the deadzone is smaller, if k is in the interval (−1, 0.5) the deadzone is larger. To reduce noise a value of kε(−0.5, 0.25) might be used to produce a deadzone between 1.5Q(u, v) and 3.0Q(u,v).

The scale factor may be controlled by rate controller 612, described in more detail below. In one embodiment, a set of scale factors that are powers of two, e.g., 1, 2, 4, 8, 16, . . . , may be used.

Entropy encoder 608 encodes the quantized values using entropy encoding to produce code words that are formatted to provide the compressed image data 610. Typically, for DCT-based compression, prior to entropy encoding, a pre-defined coefficient ordering process (zig-zag ordering) is applied to the matrix of quantized coefficients to provide a one-dimensional sequence of coefficients. For JPEG-2000 and other wavelet-based compression schemes, the ordering of coefficients consists of traversing the wavelet decomposition in a manner consistent with the wavelet's inherent properties of multi-resolution representation, progressive image transmission and high coding efficiency. (See “A Tutorial On Modern Lossy Wavelet Image Compression: Foundations of JPEG 2000,” by Byran E. Usevitch, IEEE Signal Processing Magazine, September 2001.) Once coefficient ordering is performed, a set of patterns, called symbols, is identified from the sequence of coefficients. The symbols, in turn, are mapped to code words. The symbols may be defined, for example, using a form of run length encoding. Huffman encoding is generally employed to encode the sequence of symbols to variable length codes. Alternatively, more sophisticated methods such as adaptive arithmetic coding may be employed to compress the symbols. The compressed data 610 includes the entropy encoded data and any other compressed hit-stream syntax elements for each block, macroblock, or image tiling that may be needed to decode it, such as scale factors and color space.

Compression parameters can be changed to affect both the bit rate and the image quality of decompressed data. For example, in DCT-based image compression, compression parameters that may be changed include the quantizers, either within an image between portions (i.e., coding groups) of an image, or from one image to the next. Typically, a coding group of an image is a macroblock consisting of a set of DCT blocks. A change to the quantizers affects the compressed bit rate and/or distortion level, and the image quality upon decompression. An increase in a quantizer value typically decreases the bit rate but also reduces the image quality. Conversely, a decrease in a quantizer value typically increases the bit rate but also improves the image quality. Quantizers may be adapted individually, or the set of quantizers may be scaled uniformly by a scale factor. In one embodiment, the scale factor is adjusted for each macroblock to ensure that each frame has an amount of data that matches a desired image quality or distortion level.

Rate controller 612 generally receives the bit rate 614 of the compressed data produced by compressing an image, any constraints 616 on the compression (such as buffer size, bit rate, etc.), and a distortion level as measured by distortion metric 618. The bit rate and distortion are determined for each macroblock for a number of scale factors in a statistics-gathering pass on the image. The rate controller then determines, for each macroblock, an appropriate scale factor 620 to apply to the quantization matrix. Rate controller 612 seeks to minimize bit rate 614 for a desired distortion metric 618 over the image according to the constraints 616 by using rate-distortion optimization, such as described in “Rate-distortion optimized mode selection for very low bit rate video coding and the emerging 11.263 standard,” by T. Wiegard, M. Lightstone, D. Mukherjee, T. G. Campbell, and S. K. Mitra, in IEEE Trans. Circuits Syst. Video Tech., Vol. 6, No. 2, pp. 182-190, April 1996, and in “Optimal bit allocation under multiple rate constraints,” by Antonio Ortega, in Proc. of the Data Compression Conference (DCC 1996), April 1996. In particular, the total distortion over all macroblocks in the image is optimized over the image to meet a desired distortion level and thus select a scale factor for each macroblock.

There are several ways to compute a distortion metric. For example, but not limited to this example, distortion metric 618 (d) may estimated by the square of the scale factor (q), i.e., d=q². Thus, the distortion metric is known for each scale factor without analyzing the compressed image data.

The bit rate and distortion metric corresponding to a scale factor for which quantization is not performed may be estimated by interpolating measured rate and distortion values obtained from other scale factors. Such a technique is described in “Bit-rate control using piecewise approximated rate-distortion characteristics,” by L-J. Lin and A. Ortega, in IEEE Trans. Circuits Syst. Video Tech., Vol. 8, No. 4, pp. 446-459, August 1998, and in “Cubic Spline Approximation of Rate and Distortion Functions for MPEG Video,” by L-J, Lin, A. Ortega and C.-C. Jay Kuo, in Proceedings of IST/SPIE, Digital Video Compression Algorithms and Technologies 1996, vol. 2668, pp. 169-180, and in “Video Bit-Rate Control with Spline Approximated Rate-Distortion Characteristics,” by Liang-Jin Lin, PhD Thesis, University of Southern California, 1997. For example, distortion metrics or bit rates may be computed for two scale factors, one small and one large such as 2 and 128. Interpolation between these two points may be used to obtain a suitable scale factor with a corresponding distortion level. If the resulting compressed image data exceeds the desired distortion level, the image data can be compressed again using a different scale factor.

Portions of the rate-distortion curve that extend beyond the data available also may be estimated. In particular, for any portion of an image and a quantization matrix, there is a scale factor, called the maximum scale factor. Such a scale factor causes all of the quantizers to be such that all of the coefficients are quantized to zero. The maximum scale factor provides the maximum distortion level and minimum bit rate. Distortion levels corresponding to scale factors between the maximum scale factor and a scale factor for which an actual distortion levels and bit rates are available can be estimated by interpolation, such as linear interpolation.

The coefficient compression methods described above are oriented towards minimizing a bit rate while maintaining a desired image quality as determined by a distortion level. For applications in which fixed bit rate rather than fixed image quality is desired, the desired bit rate is specified, and the coefficients are compressed using quantization and scaling factors that achieve the desired bit rate while minimizing the distortion level, as described in U.S. Pat. Nos. 7,403,561 and 7,729,423.

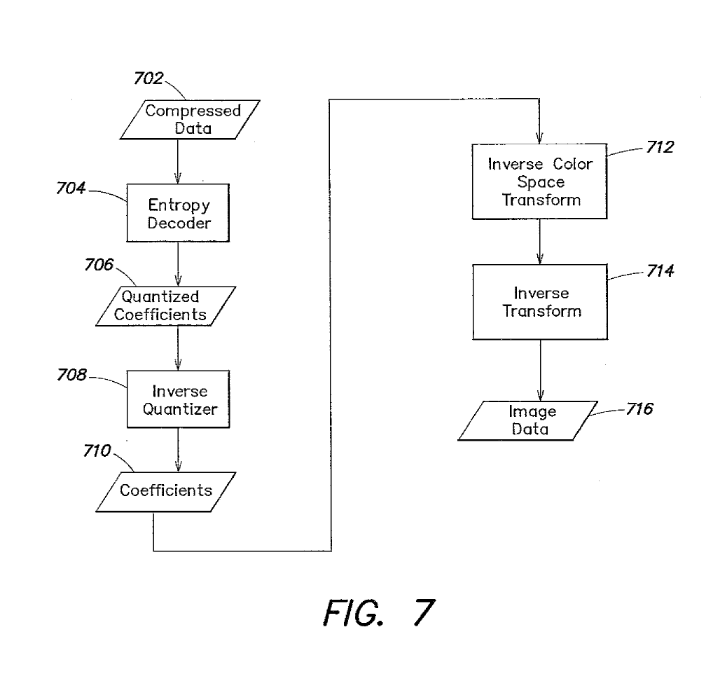

Referring now to FIG. 7, a system for decompressing or decoding image data is described. The compressed image data was generated by using a color space adaptive compression scheme as described above to compress multi-channel image data that is represented in a source color space, such as RGB 4:4:4. Compressed image data 702 is received and code words are processed by entropy decoder 704. The entropy decoder performs the inverse of the entropy encoding performed in FIG. 6. Entropy decoder 704 produces quantized coefficient data 706. Inverse quantizer 708 reverses the quantization to produce coefficients 710. The decoder reads the color space flag for each of the compressed macroblocks, and if the color space flag indicates that the color space used to represent the macroblock for compression is not the source color space, it applies inverse color space transform 712 to transform the coefficients for the macroblock into the source color space. In the final step, inverse 2D spatial linear transform 714 is applied to produce uncompressed image data 716. Inverse transform 714 is the inverse of the 2D spatial linear transform (e.g., DCT, FIG. 3, 302) that was applied when the image data was compressed to produce the coefficients.

Such encoding and decoding may be used for, for example, but not limited to, high definition video, in which images have from 720 to 1080 lines and 1280 to 1920 pixels per line. Frame rates generally vary from 23.976 to 60, with higher frame rates typically representing the field rate of an interlaced frame. Each pixel of multi-channel image data may be represented in various color spaces, such as RGB, YCbCr, with each channel represented using a number of bits (called the bit depth). The bit depth typically is 8 or 10 bits, but could be 12 or 16 bits. Such data has a significantly higher bandwidth than standard definition video. By providing the scale factors as described above, the same encoder may be used to encode both 8-bit and 10-bit data. A fixed quantization matrix may be provided for each of a number of different desired image quality levels or bit rates.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, liquid crystal displays (LCD), plasma displays, cathode ray tubes, video projection systems and other video output devices, printers, devices for communicating over a low or high bandwidth network, including network interface devices, cable modems, and storage devices such as disk or tape. One or more input devices may be connected to the computer system. Example input devices include, but are not limited to, a keyboard, keypad, track ball, mouse, pen and tablet, touch screen, communication device, and data input devices. The invention is not limited to the particular input or output devices used in combination with the computer system or to those described herein.

The computer system may be a general purpose computer system which is programmable using a computer programming language, a scripting language or even assembly language. The computer system may also be specially programmed, special purpose hardware. In a general-purpose computer system, the processor is typically a commercially available processor. The general-purpose computer also typically has an operating system, which controls the execution of other computer programs and provides scheduling, debugging, input/output control, accounting, compilation, storage assignment, data management and memory management, and communication control and related services. The computer system may be connected to a local network and/or to a wide area network, such as the Internet. The connected network may transfer to and from the computer system program instructions for execution on the computer, media data such as video data, still image data, or audio data, metadata, review and approval information for a media composition, media annotations, and other data.

A memory system typically includes a computer readable medium. The medium may be volatile or nonvolatile, writeable or nonwriteable, and/or rewriteable or not rewriteable. A memory system typically stores data in binary form. Such data may define an application program to be executed by the microprocessor, or information stored on the disk to be processed by the application program. The invention is not limited to a particular memory system. Time-based media such as video, as well as other multi-channel image data and multi-channel still images may be stored on and input from magnetic, optical, or solid state drives, which may include an array of local or network attached servers.

A system such as described herein may be implemented in software or hardware or firmware, or a combination of the three. The various elements of the system, either individually or in combination may be implemented as one or more computer program products in which computer program instructions are stored on a non-transitory computer readable medium for execution by a computer, or transferred to a computer system via a connected local area or wide area network. Various steps of a process may be performed by a computer executing such computer program instructions. The computer system may be a multiprocessor computer system or may include multiple computers connected over a computer network. The components described herein may be separate modules of a computer program, or may be separate computer programs, which may be operable on separate computers. The data produced by these components may be stored in a memory system or transmitted between computer systems.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A method for intraframe compression of video, wherein the video includes a sequence of images represented in a first color space, the method comprising, for each image:
segmenting the image into a plurality of portions;
for each portion of the image:
applying a 2D spatial linear transform to the portion to generate coefficients corresponding to the first color space;
transforming the coefficients corresponding to the first color space by applying a color space transform to generate coefficients corresponding to a second color space;
if applying the color space transform causes clipping of coefficient data, compressing the coefficients corresponding to the first color space;
if applying the color space transform does not cause clipping of the coefficients, compressing the coefficients corresponding to the second color space; and
outputting the compressed coefficient data together with an indication of the color space in which the coefficients for the portion are compressed.

2. The method of claim 1, wherein compressing the coefficients comprises:
selecting, from a plurality of stored quantization matrices each defined for a respective one of a plurality of distortion levels, a quantization matrix for the image according to a desired distortion level for the sequence of images;
determining a distortion level for the transformed portion of the image using a plurality of scale factors;
estimating a bit rate for the portion according to the plurality of scale factors;
selecting a scale factor for the portion to minimize the overall bit rate for the compressed image while achieving a desired distortion level;
quantizing the frequency domain coefficients for the portion using the selected quantization matrix as scaled by the selected scale factor for the portion; and
entropy encoding the quantized coefficients using a variable length encoding to provide compressed data for the portion.

3. The method of claim 1, wherein the first color space is an RGB color space.

4. The method of claim 1, wherein the first color space is an RGB 4:4:4 color space.

5. The method of claim 1, wherein the second color space is a YCbCr 4:4:4 color space.

6. The method of claim 1, wherein each of the plurality of portions of the image comprises a block of 16 by 16 pixels.

7. The method of claim 1, wherein the 2D spatial linear transform is a discrete cosine transform.

8. The method of claim 1, wherein the 2D spatial linear transform is a wavelet transform.

9. The method of claim 1, wherein compressing the coefficients comprises:
selecting, from a plurality of stored quantization matrices each defined for a respective one of a plurality of bit rates, a quantization matrix for the image according to a desired bit rate of the plurality of bit rates for the sequence of images;
determining a distortion metric for the transformed portion of the image using a plurality of scale factors;
estimating a bit rate for the portion according to the plurality of scale factors;
selecting a scale factor for the portion to minimize the total distortion in the image, while achieving a desired bit rate;
quantizing the frequency domain coefficients for the portion using the selected quantization matrix as scaled by the selected scale factor for the portion; and
entropy encoding the quantized frequency domain coefficients using a variable length encoding to provide compressed data for the portion.

10. A method for intraframe compression of video, wherein the video includes a sequence of images represented in a first color space, the method comprising, for each image:
segmenting the image into a plurality of portions;
for each portion of the image:
applying a 2D spatial linear transform to the portion to generate coefficients corresponding to the first color space;
transforming the coefficients by applying a color space transform to generate coefficients corresponding to a second color space for the portion;
if applying the color space transform causes clipping of the coefficients, compressing the coefficients corresponding to the first color space;
if applying the color space transform does not cause clipping of the coefficients:
determining a first and a second compression efficiency of compressing the coefficients for the portion corresponding to the first and second color spaces respectively;
comparing the first and second compression efficiencies to determine an optimal one of the first and second color spaces that yields a greater compression efficiency for the portion;
compressing the coefficients corresponding to the optimal one of the first and second color spaces; and
outputting the compressed data for the portion together with an indication of the optimal one of the first and second color spaces for the portion.

11. The method of claim 10, wherein determining compression efficiency corresponding to a color space comprises computing a number of bits in a compressed bitstream representing the coefficients without actually computing the compressed bitstream itself.

12. The method of 11, wherein computing the number of bits in the compressed bitstream is based on a bit-cost model of the number of bits required to represent the portion for a given distortion level.

13. A method for compression of multi-channel image data represented in a first color space, the method comprising:
segmenting the image data into a plurality of portions;
for each portion of the image:
transforming the portion using a 2D spatial linear transform to generate coefficients corresponding to the first color space;
determining a compression efficiency of compressing the coefficients corresponding to the first color space for the portion;
for each of one or more additional color spaces:
transforming the coefficients by applying a color space transform to generate coefficients corresponding to the additional color space; and
if applying the color space transform does not cause clipping of the coefficients determining a compression efficiency of compressing the coefficients for the portion corresponding to the additional color space;
comparing the compression efficiencies corresponding to the first color space and each of the one or more additional color spaces to determine an optimal color space that yields a greatest compression efficiency for the portion;
compressing the coefficients corresponding to the optimal color space to generate compressed image data for the portion; and
outputting the compressed image data for the portion together with an indication of the optimal color space for the portion.

14. The method of claim 13, wherein the first color space is one of a CMYK and a YCbCrK color space.

15. The method of claim 13 wherein the first color space is a CMYK color space and an additional color space is a YYCC color space.

16. The method of claim 13, wherein the multi-spectral image data represents a still image.

17. The method of claim 13, wherein the multispectral image data represents a temporal sequence of images.

18. A computer program product comprising:
a computer-readable medium with computer program instructions encoded thereon, wherein the computer program instructions, when processed by a computer, instruct the computer to perform a method for intraframe compression of video, wherein the video includes a sequence of images represented in a first color space, the method comprising, for each image:
segmenting the image into a plurality of portions;
for each portion of the image:
applying a 2D spatial linear transform to the portion to generate coefficients corresponding to the first color space;
transforming the coefficients corresponding to the first color space by applying a color space transform to generate coefficients corresponding to a second color space;
if applying the color space transform causes clipping of coefficient data, compressing the coefficients corresponding to the first color space;
if applying the color space transform does not cause clipping of the coefficients, compressing the coefficients corresponding to the second color space; and
outputting the compressed coefficient data together with an indication of the color space in which the coefficients for the portion are compressed.

19. A computer system for intraframe compression of video, wherein the video includes a sequence of images represented in a first color space, the computer system comprising:
a processor programmed to:
for each image of the sequence of images:
input the image;
segment the image into a plurality of portions;
for each portion of the image:
apply a 2D spatial linear transform to the portion to generate coefficients corresponding to the first color space;
transform the coefficients corresponding to the first color space by applying a color space transform to generate coefficients corresponding to a second color space;
if applying the color space transform causes clipping of coefficient data, compress the coefficients corresponding to the first color space;
if applying the color space transform does not cause clipping of the coefficients, compress the coefficients corresponding to the second color space; and
output the compressed coefficient data together with an indication of a color space in which the coefficients for the portion are compressed.

20. A method for decompression of compressed mufti-channel image data, wherein the compressed image data was generated by intraframe compression of a sequence of multi-channel images represented in a source color space, the method comprising, for each image:
receiving a compressed bitstream of intraframe compressed image data;
determining an associated quantization matrix for the compressed bitstream;
entropy decoding the compressed data using variable length decoding to obtain quantized 2D spatial linear transform domain coefficients for defined portions of the image; and
for each portion:
determining a scale factor for the portion;
inverse quantizing the 2D spatial linear transform domain coefficients for the portion using the associated quantization matrix as scaled by the determined scale factor for the portion;
reading a color space signal in the received bitstream for the portion that indicates a color space in which the compressed data for the portion is represented;
if the color space for the portion is not the source color space, applying an inverse color space transform to transform the data for the portion from the color space to the source color space; and
inverse transforming the dequantized, source color space 2D spatial linear transform domain coefficients for each portion to generate a portion of the image.
